(19) United States
(12) Patent Application Publication
(10) Pub. No.: US 2008/0020162 A1
(43) Pub. Date: Jan. 24, 2008

(54) Packaging Material Comprising a Foamed Polyolefin Layer

(75) Inventors: Tobias Fackler, Bad Gronenbach (DE); Walter Bernig, Durach (DE); Bernard Dujardin, Brussel (BE)

Correspondence Address: NORRIS, MCLAUGHLIN & MARCUS, P.A., 875 THIRD AVE, 18TH FLOOR, NEW YORK, NY, 10022, US

(73) Assignee: CFS Kempten Gmbh, Kempten (DE)

(21) Appl. No.: 10/577,090

(22) PCT Filed: Oct. 25, 2004
(86) PCT No.: PCT/EP04/12029

§ 371 Date: Jan. 19, 2007

(30) Foreign Application Priority Data
Oct. 27, 2003 (DE) 10350237.8

(51) Int. Cl. B32B 5/18; B65D 65/40

(52) U.S. Cl. 428/36.5; 426/415; 428/158; 428/159

(57) ABSTRACT

The invention relates to a multilayer film comprising the following sequence of layers: A) a polyolefin foam base layer containing 0.5 to 25 percent by weight of at least one nucleation agent; B) a layer based on at least one polyolefin of foam layer A); C) an optional polyolefin-based connecting layer; D) an optional bonding layer; E) an optional gas-tight and/or odor-proof barrier layer; F) a bonding layer; G) an optionally sealable and/or peelable surface layer. The total thickness of layers A) and B) ranges between 0.5 and 2 mm while the thickness of layer B) ranges between one sixth and one half of the thickness of layer A).

The invention is concerned with the packaging industry and relates to a packaging material which has a foamed polyolefin layer as an outer layer, which comprises on the surfaces thereof further layers and to packaging produced therefrom.

Packaging materials with a foam layer of for example polypropylene in the form of virtually continuous, reeled webs are used for the production of thermoformed, self-supporting packages such as for example trays for packaging foodstuffs. To this end, such packaging materials may be converted into packages on “FFS machines” (form-fill-seal machines), wherein the packaging material in web form is fed into a forming apparatus, is shaped therein into a web of trays, the material to be packaged is introduced into the trays, which are closed by heat-sealing with a preferably transparent film. The closed trays may then be separated from one another.

In known packaging materials, the layer of foamed polyolefin is provided with further layers on at least one side of its surface. Depending on the composition and thickness of these layers, they may increase the rigidity of the packaging material and/or serve as a protection for the foam surface and/or as a gas and/or aroma barrier and/or as a surface layer for heat-sealing a filled packaging tray with a preferably transparent lidding film.

Packaging materials comprising a layer of foamed polypropylene for the production of packaging trays by thermoforming are described for example in EP-A-0 570 222. These materials comprise a foam layer and a multilayer composite film, which may optionally contain a barrier layer which makes the packaging material gas- and aroma-tight. This multilayer packaging material does not always exhibit the desired properties for self-supporting packages.

EP-B-1 117 526 discloses complementing the foam layer with a compact layer of a polyolefin of the foam layer while maintaining a specific thickness ratio of these two layers to one another in order to improve the self-supporting properties of packages produced from this packaging material without increasing the thickness of the packaging material.

Although this packaging material may very readily be converted into packages, for example by thermoforming, there is a requirement due to ever higher packaging machinery running speeds to improve the packaging material in such a manner that it permits higher production speeds, i.e. shorter cycle times, without, for example, irregularities in the wall thickness of the packaging container consequently arising and without the mechanical strength or rigidity and thus the self-supporting properties of the packaging container being impaired.

Said object is achieved according to the invention by providing a multilayered film which comprises the following sequence of layers:
A) a base layer of polyolefin foam containing 0.5 to 25 wt. %, relative to the total weight of the base layer, of at least one nucleating agent,
B) a layer based on at least one polyolefin of the foam layer A),
C) optionally a bonding layer based on a polyolefin, which is preferably based on the particular monomer which is the main monomer of the polyolefin of foam layer A),
D) optionally a coupling agent layer,
E) optionally a gas- and/or aroma-barrier layer,
F) a coupling agent layer,
G) an optionally heat-sealable and/or peelable surface layer,
   wherein the total thickness of layers A) and B) is in the range from 0.5 to 2 mm and the thickness of layer B) is in the range from ⅙ to ½ of the thickness of layer A).

The total thickness of layers A) and B) is preferably in the range from 0.6 to 1.4 mm and the thickness of layer B) is in the range from ⅙ to ⅓ of the thickness of layer A).

The foam layer A) consists of at least one foamed polyolefin. Foamed propylene homo- and/or copolymers are here particularly suitable for the production of packages, such as for example packaging trays for packaging foodstuffs, as these materials exhibit self-supporting properties even when they are of low thickness and low density. It is also possible to use blends of polyolefins to produce the foam layer. A blend of polypropylene having long-chain branching and thus elevated melt strength and a propylene-ethylene copolymer, such as for example a heterophase propylene-ethylene block copolymer is in particular suitable. In particular, a blend of a polypropylene with long-chain branching and a melt flow index (MFI) in the range from 1.4 to 4.2 g/10 min (2.16 kg, 230° C. measured according to ISO 1133) and a heterophase propylene-ethylene block copolymer in a mixing ratio of 1:1 is suitable.

Foaming of the polyolefin of layer A) may proceed by the addition of solid, liquid and/or gaseous blowing agents, which are added to the polyolefin in conventional quantities, preferably in an amount of 0.5 to 3 wt. %. Reference is here made to the disclosure in EP-A-0 570 222, which is hereby introduced as a reference and deemed to be part of the present disclosure.

The foam layer A) contains 0.5 to 25 wt. %, preferably 2.1 to 20 wt. %, particularly preferably more than 2.5 to 15 wt. %, relative to the total weight the foam layer A), of at least one nucleating agent. The nucleating agent is preferably finely divided with an average particle size in the range from 4 to 20 μm.

Suitable nucleating agents are any known solid nucleating agents, preferably synthetic or natural inorganic compounds. At least one nucleating agent selected from among the group comprising talcum, titanium dioxide, silicon dioxide, calcium carbonate, magnesium silicate, aluminium silicate, calcium phosphate and montmorillonite is particularly preferably used. Talcum is very particularly preferably used.

The nucleating agent is added to the polymer from which the foam layer is to be produced, preferably in the form of a masterbatch which contains 30 to 60 wt. % of nucleating agent in the polymer, and is largely homogeneously dispersed therein prior to foaming.

The foam layer A) obtained therefrom are distinguished by an elevated number of cells with relatively small size deviations. The cell count is preferably greater than or equal to 250 cells/mm³, particularly preferably greater than or equal to 300 cells/mm³ up to 600 cells/mm³, the size variations of the cells being in the range of ±15%, preferably ±10%. The density of the foam layer A) is preferably in the range from 0.35 to 0.55 g/cm³.

The density and cell count may moreover be varied by process parameters, such as for example extrusion temperature or other process parameters, during the preferred production of the foam layer by extrusion and expansion.

Layer B) of compact polyolefin is substantially based on at least one polyolefin of the foamed base layer A). If this base layer consists of foamed polypropylene or a foamed blend of polypropylene and propylene-ethylene copolymer, the compact polyolefin layer B) is preferably based on polypropylene or a propylene-ethylene copolymer. A heterophase propylene-ethylene block copolymer is particularly preferred. The melt flow index (MFI) of the polyolefins used to produce layer B) is preferably in the range from 1.8 to 5.5 g/10 min measured as stated above. The thickness of layer B) amounts to ⅙ to ½, particularly preferably to ⅙ to ⅓ of the thickness of layer A).

Layer C) is preferably present, if layers D) to G) are prefabricated by coextrusion, preferably by blown film coextrusion, and are to be bonded with the other layers. Layer C) is based on a polyolefin, which has preferably been produced from a monomer which is also the main monomer of the polyolefins of which foam layer A) consists. Accordingly, if layer A) consists of a foamed polypropylene and optionally a propylene-ethylene copolymer, layer C) may consist of polypropylene which optionally comprises grafted maleic anhydride units. Copolymers of ethylene-vinyl acetate may also be used as a further component. The thickness of layer C) is preferably 5 to 25 μm, particularly preferably 8 to 15 μm.

If the multilayer films according to the invention are to exhibit low gas permeability, i.e. low oxygen and moisture permeability together with aroma protection, they comprise a barrier layer E). This barrier layer is preferably composes of an ethylene-vinyl alcohol copolymer comprising a proportion of ethylene of 32 to 45 mol %, preferably of 35 to 42 mol %. The barrier layer E) may be bonded with the assistance of a coupling agent layer D) or F) on its respective surface with the bonding layer C) and with the heat-sealing layer G). The material used for this purpose is preferably a propylene copolymer or a polyethylene which comprises grafted maleic anhydride units.

The surface layer G), which forms the 2nd outer layer of the multilayer film according to the invention, is preferably heat-sealable and/or peelable. This layer is thus preferably produced using a low density polyethylene (LDPE) with a melt flow index (MFI) in the range from 0.5 to 8.0 g/10 min, preferably in the range from 1 to 5 g/10 min (2.16 kg, 190° C. measured according to ASTM D1238) or an ionomer, such as for example a copolymer of an α-olefin and an ethylenically unsaturated carboxylic acid, wherein the carboxyl groups are present in an amount of 20 to 100 mol % as a metal salt, preferably as a sodium salt, or an ethylene-vinyl acetate copolymer with a vinyl acetate content of 3 to 10 wt. %, preferably of 4 to 6 wt. %, for the production of the heat-sealable layer.

According to a particularly preferred embodiment, the heat-sealing layer is also peelable. To this end, a blend of LDPE and a polybutylene (PB) is preferably used as the layer material. The blend preferably contains 15 to 30 wt. %, preferably 20 to 28 wt. %, of polybutylene. The polybutylene preferably has a melt flow index (MFI) in the range from 0.3 to 2.0 g/10 min (190° C. and 2.16 kg according to ASTM 1238).

The thickness of the surface layer is preferably in the range from 10 to 50 μm, preferably from 15 to 30 μm.

If LDPE is used as the polymer for the production of the heat-sealing layer G) and the multilayer film according to the invention also comprises a barrier layer, a coupling agent layer is then preferably necessary for bonding the barrier layer and the heat-sealing layer, unless an ethylene-vinyl alcohol copolymer is used as the barrier layer material. A polyolefin, preferably a polyethylene with grafted maleic anhydride units, may be used as the material for the coupling agent layer. It is, however, also possible to use a blend of LDPE and LLDPE in the ratio 3:1 to 4:1. The thickness of the particular coupling agent layer is in the range from 2 to 8 μm, preferably in the range from 3 to 6 μm.

The surface layer G) may contain conventional and known antibiotics, slip agents and antiblocking agents, such as for example erucamide, polyalkylsiloxanes, such as for example polydimethylsiloxane and/or silicon dioxide.

All or only individual layers of the multilayer film according to the invention may contain stabilisers and further additives of a known kind.

Layer B) may moreover contain 0.5 to 2 wt. % of a white pigment, such as for example kaolin, calcium carbonate, talcum, titanium dioxide or mixtures thereof. Such inorganic pigments are preferably added to the polymer, from which layer B) is produced, in the form of a masterbatch which contains 30 to 70 wt. % of pigments.

The multilayer films according to the invention may preferably be produced by conventional blown film coextrusion processes or by flat film coextrusion processes, inasmuch as this relates to the sequence of layers C) to G), and is preferably bonded with the polyolefin foam layer A) by an extrusion lamination step.

To this end, the foam layer A) and the multilayer film, consisting of layers C) to G), are brought together in such a manner that layer B) is extruded therebetween. Immediately after extrusion, a sufficiently large pressure is applied onto the resultant laminate to ensure that layers A) to G) are adequately bonded to one another.

It is, however, also possible to produce the multilayer films according to the invention solely by coextrusion, wherein the foam layer A) is coextruded simultaneously with the other layers, optionally omitting layer C), and layer A) is simultaneously foamed.

The multilayer films according to the invention exhibit excellent thermoformability on “FFS” machines (form-fill-seal machines) and may be converted on these machines into packaging containers, preferably into thermoformed packaging trays, then filled and sealed. It was surprising that the multilayer films according to the invention may excellently be processed on FFS machines at an elevated production speed and, in comparison with a packaging material without the modification according to the invention, permit up to 10% shorter cycle times and thus an up to 10% higher output of packaging trays without any impairment of the uniformity of wall thickness.

In comparison with comparable known, unmodified packaging materials, the multilayer films according to the invention also exhibit an unexpected improvement in mechanical properties, in particular in rigidity measured by the modulus of elasticity in machine direction and in tensile stress. This distinct improvement is manifested without its being necessary to increase the thickness of the multilayer films which are known from the prior art.

The packages produced from the multilayer films according to the invention moreover exhibit distinctly more uniform surface structure, virtually without foam tears, so likewise improving the handling thereof.

The present invention accordingly also provides the use of the multilayer film according to the invention as a packaging material, preferably on form-fill-seal machines (FFS machines), for packaging foodstuffs, in particular for packaging of highly perishable foodstuffs, such as meat, ham or sliced foodstuffs. Since packaging is often carried out discontinuously on these machines, in order to package different products, the packaging material must also exhibit a relatively wide thermoforming “window” over which it may be thermoformed. This is the case for the packaging material according to the invention, as it exhibits excellent thermoformability, in particular vacuum formability.

The thermoformed, preferably vacuum formed packaging articles, such as for example packaging trays, preferably vacuum formed packaging trays, which have been produced from the multilayer films according to the invention, may, once filled, be sealed with known lidding films. Suitable lidding films are multilayer films, preferably made from polyethylene terephthalate/SiOx/coupling agent layer/low density polyethylene or from polyethylene terephthalate/coupling agent layer/polyethylene/coupling agent layer/ethylene-vinyl alcohol copolymer/coupling agent layer/polyethylene.

Among the stated lidding films, the first-stated multilayer films are in particular suitable. To this end, the biaxially oriented polyethylene terephthalate is coated with SiOₓ by plasma vacuum processing. The already fabricated polyethylene film is then laminated thereto with the assistance of a coupling agent. Such a lidding film is in particular distinguished by excellent transparency and elevated breaking strength. Packages comprising such a lidding film moreover exhibit excellent gas barrier properties.

In the following Examples, modulus of elasticity and tensile stress are determined according to ISO 527-2 in machine direction and in the transverse direction.

### EXAMPLES

### Example 1

A multilayer film according to the invention with following layer structure:
Layer A) a foam layer with a density of 0.47 g/cm³ and a cell count of 492 cells/mm³ made from a blend of 50 wt. % polypropylene with long-chain branching (high melt strength polypropylene) and 46 wt. % of a heterophase propylene-ethylene block copolymer and 4 wt. % of finely divided talcum.
Layer B) made from 100 wt. % of a heterophase propylene-ethylene block copolymer corresponding to the block copolymer of foam layer A)
Layer C) made from a polypropylene,
Layer D) made from a coupling agent based on polypropylene grafted with maleic anhydride units,
Layer E) as a gas barrier layer based on an ethylene-vinyl alcohol copolymer,
Layer F) as a coupling agent layer with the same structure as layer D),
Layer G) as a heat-sealing layer based on low density polyethylene.

The multilayer film is produced by coextrusion. The thickness of the individual layers is stated in Table 1.

TABLE 1

| Layer | A) | B) | C) | D) | E) | F) | G) | Total |
|---|---|---|---|---|---|---|---|---|
| Thickness | 1130 | 264 | | 5 | 5 | 5 | 20 | 1444 |
| in μm | | | | | | | | |

The mechanical properties of this film are stated in Table 2.

### Comparative Example 1

Corresponding to the multilayer film according to Example 1, a multilayer film was produced with an identical sequence of layers and, with the exception of layer A), with identical layer compositions and identical film thicknesses, wherein layer A) comprised the same polymer composition as in Example 1, but no nucleating agent.

The mechanical properties of the multilayer film according to the Comparative Example are stated in Table 2.

TABLE 2

| | | Comparative | |
|---|---|---|---|
| | Unit | Example 1 | Example 1 |
| Modulus of elasticity | MPa | 519 | 703 |
| (machine direction) | | | |
| Modulus of elasticity | MPa | 280 | 280 |
| (transverse direction) | | | |
| Tensile stress (machine | MPa | 9.3 | 12.0 |
| direction) | | | |
| Tensile stress (transverse | MPa | 7.4 | 9.5 |
| direction) | | | |
| Cycle times | Cycles/minute | 8 | 9 |

It is clear from Table 2 that the multilayer film according to the invention exhibits far better mechanical values than a multilayer film with an unmodified foam layer A).

1. A multilayer film comprising the following sequence of layers:
A) a base layer of polyolefin foam containing 0.5 to 25 wt. %, relative to the total weight of the base layer, of at least one nucleating agent,
B) a layer formed of at least one polyolefin of the foam layer A)
C) optionally a bonding layer comprised of a polyolefin,
D) optionally a coupling agent layer,
E) optionally a gas- and/or aroma-barrier layer,
F) a coupling agent layer,
G) an optionally heat-sealable and/or peelable surface layer wherein the total thickness of layers A) and B) is in the range from 0.5 to 2 mm and the thickness of layer B) is in the range from ⅙ to ½ of the thickness of layer A).

2. A multilayer film according to claim 1, wherein the total thickness of layers A) and B) is in the range from 0.6 to 1.4 mm.

3. A multilayer film according to claim 1, wherein the thickness of layer B) is in the range from ⅙ to ⅓ of the thickness of layer A).

4. A multilayer film according to claim 1, wherein layer A) is comprised of foamed polypropylene or a foamed blend of polypropylene with long-chain branching and a propylene-ethylene copolymer.

5. A multilayer film according to claim 1, wherein layer A) contains 2.1 to 20 wt. % of the nucleating agent.

6. A multilayer film according to claim 1, wherein said nucleating agent comprises at least one member of the group consisting of talcum, titanium dioxide, silicon oxide, calcium carbonate, magnesium silicate, aluminum silicate, calcium phosphate and montmorillonite.

7. A multilayer film according to claim 1, wherein layer B) is formed of polypropylene or a propylene-ethylene copolymer.

8. A multilayer film according to claim 1, wherein layer C) is present and said polvolefin is formed of the monomer which is the greatest monomer component of the polyolefin of the foam layer A).

9. A multilayer film according to claim 1, wherein layer E) is present and is formed of an ethylene-vinyl alcohol copolymer.

10. A multilayer film according to claim 1, wherein layer G) is present and is formed of a heat-sealable polymer, and optionally contains conventional additives.

11. A multilayer film according to claim 1, wherein layer G) is formed of peelable polymers and optionally contains conventional additives.

12. A multilayer film according to claim 1, wherein the total thickness of layers C) to G) amounts to 20 to 70 μm.

13. A packaging material comprising the multilayer film of claim 1.

14. A packaging container made from a film of claim 1.

15. A method for packaging foodstuffs, which comprises packaging said foodstuffs in a packaging container of claim 14.

16. The method of claim 24, wherein said solid foodstuffs are meat, sausage or cheese.

17. A method for preparing a packaging material which comprises preparing said packaging material of a multilayer film of claim 1 on a form-fill-seal machine.

18. The multilayer film of claim 4, wherein said propylene-ethylene copolymer is a heterophase propylene-ethylene block copolymer.

19. The multilayer film of claim 5, wherein said amount of nucleating agent is 2.5 to 15 wt. %.

20. The multilayer film of claim 8, wherein said layer C) is polypropylene.

21. The multilayer film of claim 10, wherein said heat-sealable polymer is a low density polyethylene or an ionomer.

22. The multilayer film of claim 11, wherein said peelable polymers are a blend of low density polyethylene and a polybutylene.

23. The multilayer film of claim 12, wherein said total thickness of layers C) to G) is 30 to 50 μm.

24. The method of claim 15, wherein said foodstuffs are solid foodstuffs.
